(19) United States
(12) Patent Application Publication
(10) Pub. No.: US 2013/0319708 A1
(43) Pub. Date: Dec. 5, 2013

(54) HAMMER MECHANISM

(71) Applicants: Joachim Hecht, Magstadt (DE); Martin Kraus, Filderstadt (DE)

(72) Inventors: Joachim Hecht, Magstadt (DE); Martin Kraus, Filderstadt (DE)

(21) Appl. No.: 13/989,224

(22) PCT Filed: Oct. 14, 2011
(86) PCT No.: PCT/EP2011/067974

§ 371 Date: Aug. 12, 2013

(30) Foreign Application Priority Data
Nov. 29, 2010 (DE) 10 2010 062 106.4
Apr. 19, 2011 (DE) 10 2011 007 691.3

(51) Int. Cl. B25D 16/00

(52) U.S. Cl. CPC B25D 16/00
USPC 173/109

(57) ABSTRACT

A hammer mechanism is provided, which has at least one impact-generation unit which includes a strike element, a clamping chuck drive shaft mounting the strike element in movable manner in the strike direction in at least one operating state, and a coupling unit which is connected to the clamping chuck drive shaft in torsionally fixed manner and provided to drive the impact-generation unit.

### BACKGROUND OF THE INVENTION

1. Field of the Invention

The present invention relates to a handheld machine tool having a hammer mechanism.

2. Description of the Related Art

Handheld machine tools which have an impact-generation unit, in which a hammer means is supported inside a hammer cylinder so as to be able to move are already known. The hammer cylinder, a clamping chuck and a wobble bearing of the impact-generation unit are driven by an intermediate shaft.

### BRIEF SUMMARY OF THE INVENTION

A hammer mechanism is described, which has at least one impact-generation unit provided with a hammer means, a clamping chuck drive shaft mounting the hammer means in a manner that allows it to move in the strike direction in at least one operating state, and a coupling means, which is connected to the clamping chuck drive shaft in torsionally fixed manner and drives the impact-generation unit. An “impact-generation unit” in particular denotes a unit provided to translate a rotary motion into an, in particular, translatory strike motion of the hammer means which is suitable for drilling or impact drilling. In particular, the impact-generation unit is developed as an impact-generation unit considered useful by the expert, but preferably is implemented as a pneumatic impact-generation unit and/or, especially preferably, as an impact-generation unit having a rocker lever. A “rocker lever” in particular denotes a means that is mounted so as to allow movement about a pivot axis and which is provided to output power that was picked up in a first coupling area, to a second coupling area. A “hammer means” in particular denotes a means of the hammer mechanism that is meant to be accelerated by the impact-generation unit, in particular in translatory fashion, during its operation, and to output a pulse, picked up during the acceleration, in the direction of an inserted tool in the form of a strike pulse. The strike means preferably is supported by air pressure or, advantageously, by a rocker lever, such that it is able to be accelerated in the strike direction. Immediately prior to a strike, the strike means preferably is in a non-accelerated state. During a strike, the strike means preferably outputs a strike pulse in the direction of the inserted tool, in particular via a snap die. A “clamping chuck drive shaft” in particular denotes a shaft which transmits a rotary motion from a gearing, especially a planetary gearing, in the direction of a clamping chuck during a drilling and/or an impact drilling operation. Preferably, the shaft is at least partially developed as full shaft. The clamping chuck drive shaft preferably extends across at least 40 mm in the strike direction. In a drilling and/or in an impact drilling operation, the clamping chuck drive shaft and the clamping chuck have the same rotational speed, preferably always, i.e., no gear unit is provided on a drive train between the clamping chuck drive shaft and the clamping chuck. The term “clamping chuck” in particular denotes a device provided for the direct mounting of an inserted tool in at least torsionally fixed manner by a user, especially in a manner that is reversible without using a tool. A “strike direction” in particular denotes a direction that extends parallel to an axis of rotation of the clamping chuck and which runs from the strike means in the direction of the clamping chuck. The strike direction preferably is aligned parallel to an axis of rotation of the clamping chuck drive shaft. The term “mount so as to allow movement” specifically means that the clamping chuck drive shaft has a bearing surface which in at least one operating state transmits bearing forces to the strike means, in a direction perpendicular to the strike direction. A “coupling means” in particular denotes a means provided to transmit a motion from one component to another component at least by a keyed connection. The keyed connection preferably is designed to be reversible by the user in at least one operating state. In an especially preferred manner, the keyed connection is reversible for a switch between operating modes, i.e., advantageously between a screwing, drilling, cutting and/or an impact drilling operation. The coupling means in particular is developed as a coupling considered useful by the expert, but advantageously takes the form of a dog clutch and/or toothing. The coupling means advantageously includes a plurality of keyed connection elements and a region that connects the keyed connection elements. “In torsionally fixed manner” in particular means that the coupling means and the clamping chuck drive shaft are fixedly connected to each other in at least the circumferential direction, preferably in all directions, and, in particular, in all operating states. “Provided” in particular means specially configured and/or equipped. “Drive” in this context in particular describes that the coupling means transmits kinetic energy, especially rotational energy, to at least one region of the impact-generation unit. Preferably, the impact-generation unit uses this energy to drive the strike means. The development according to the present invention makes it possible to provide an especially compact and powerful hammer mechanism using constructively simple measures.

In addition, it is provided to develop the coupling means in one piece with the clamping chuck drive shaft, so that an inexpensive production is able to be realized. As an alternative or in addition, the coupling means could also be joined to the clamping chuck drive shaft in some other way that appears useful to the expert, but it is advantageously press-fitted, screw-fitted or joined in form-fitting manner in the circumferential direction and axially via a safety ring or a band. “In one piece” in particular means at least integrally, e.g., using a welding process, a bonding process, an injection-molding process or some other process considered expedient by the expert and/or is advantageously formed in one piece, for example by producing it from a casting and/or advantageously, from a single blank.

In another development, the coupling means dips into a coupling means of the impact-generation unit, at least when a strike mode is activated, which advantageously requires little design space. An “activation of a strike mode” in particular describes an adjustment process in which the operator in particular adjusts the hammer mechanism in such a way that the impact-generation unit drives the hammer means in a striking manner while operating. In the process, the operator preferably switches from a drilling and/or screwing mode into an impact drilling and/or cutting mode. “Dipping into a coupling means” in particular means that the coupling means is situated outside a recess of the impact-generation unit in one operating mode and is moved into the recess when the strike mode is activated. A “recess” in particular means a region delimited by the impact-generation unit which is enclosed by the coupling means over more than 180 degrees, advantageously more than 270 degrees, especially advantageously, over 360 degrees, on at least one plane which advantageously is aligned perpendicularly to the strike direction.

Furthermore, it is provided that the clamping chuck drive shaft penetrates the strike means at least partially, so that a clamping chuck drive shaft having an especially low mass and small space requirement is able to be realized. The phrase “penetrates at least partially” in particular means that the hammer means encloses the clamping chuck drive shaft over more than 270 degrees, advantageously over 360 degrees, on at least one plane that advantageously is oriented perpendicularly to the strike direction. Preferably, the hammer means is mounted on the clamping chuck drive shaft in form-fitting manner in a direction perpendicular to the axis of rotation of the clamping chuck drive shaft, i.e., supported in movable manner in the direction of the axis of rotation.

In addition, it is provided that the hammer mechanism includes at least one bearing, which mounts the clamping chuck drive shaft in axially displaceable manner and thereby provides a simple way of deactivating the hammer mechanism. A “bearing” in this context specifically describes a device which mounts the clamping chuck drive shaft especially in relation to a housing in a manner that allows movement about the axis of rotation and an axial displacement. The phrase “axial displacement” in particular means that the bearing mounts the clamping chuck drive shaft in a manner that allows it to move, especially relative to a housing, in a direction parallel to the strike direction. A connection of the coupling means of the clamping chuck drive shaft driving the impact-generation unit preferably is reversible by shifting the clamping chuck drive shaft in the axial direction.

It is furthermore provided that the hammer mechanism includes a planetary gearing which drives the clamping chuck drive shaft in at least one operating state, so that an advantageous translation is able to be achieved using little space. Moreover, a torque restriction and a plurality of gear stages are realizable by simple constructive measures. A “planetary gearing” in particular means a unit having at least one planetary wheel set. A planetary wheel set preferably includes a sun gear, a ring gear, a planetary wheel carrier and at least one planetary wheel which is guided along a circular path about the sun gear by the planetary wheel carrier. Preferably, the planetary gearing has at least two translation ratios, selectable by the operator, between an input and an output of the planetary gearing.

In one advantageous development of the present invention, the clamping chuck drive shaft has an additional coupling means, which is provided to produce an axially displaceable, torsionally fixed connection to the planetary gearing, so that a simple design is achievable. An “axially displaceable, torsionally fixed connection” in particular describes a connection provided to transmit a force in the circumferential direction and to allow movement of the clamping chuck drive shaft relative to the planetary gearing.

Furthermore, the hammer mechanism includes a torque-restriction device provided to restrict a torque that is maximally transmittable via the clamping chuck drive shaft, so that the operator is advantageously protected and the handheld tool is able to be used in a comfortable and safe manner for screw-fitting operations. “Restrict” in this context in particular means that the torque-restriction device prevents an exceeding of the maximal torque adjustable by an operator, in particular. The torque-restriction device preferably releases a connection between a drive motor and the clamping chuck, which is torsionally fixed during operation. As an alternative or in addition, the torque-restriction device may act on an energy supply of the drive motor.

Furthermore, the hammer mechanism has a clamping chuck and a snap die provided with a coupling means for transmitting a rotary motion to the clamping chuck, thereby creating an especially compact hammer mechanism. The snap die advantageously transmits a rotary motion of the clamping chuck drive shaft to the clamping chuck. A “snap die” in particular means an element of the hammer mechanism that transmits the strike pulse from the hammer means in the direction of the inserted tool during a strike operation. The snap die preferably strikes the inserted tool directly in at least one operating state. The snap die preferably prevents dust from making its way through the clamping chuck into the hammer mechanism.

In addition, the impact-generation unit includes a spur gear transmission stage which translates a rotational speed of the clamping chuck drive shaft into a higher rotational speed for impact generation, and thereby makes it possible in a space-saving and uncomplicated manner to achieve an especially advantageous ratio between the rotational speed and the number of strikes of an inserted tool. A “spur-gear transmission stage” in particular denotes a system of especially two toothed wheel works engaging with one another, which are mounted so as to be rotatable about parallel axes. On a surface facing away from their axis, the toothed wheel works preferably have gear teeth. A “rotational speed for strike generation” in particular is a rotational speed of a drive means of the impact-generation unit considered useful by the expert, which drive means translates a rotary motion into a linear motion. The drive means of the impact-generation unit preferably is developed in the form of a wobble bearing or, especially preferably, as an eccentric element. “Translate” in this case means that there is a difference between the rotational speed of the clamping chuck drive shaft and the rotational speed for the impact generation. The rotational speed for an impact generation preferably is higher, advantageously at least twice as high as the rotational speed of the clamping chuck drive shaft. Especially preferably, a translation ratio between the rotational speed for impact generation and the rotational speed of the clamping chuck drive shaft is a non-integer ratio.

Moreover, the hammer mechanism includes an impact-generation deactivation unit equipped with a blocking element which acts on the snap die, parallel to at least one force of the clamping chuck drive shaft, at least in a drilling operation and especially in a screwing operation, so that an advantageous placement of an operating element of the impact-generation deactivation unit is possible using measures that are uncomplicated in terms of design. In particular, an annular operating element, which encloses the snap die or the clamping chuck drive shaft, is easily able to be realized. In addition, this development requires little space. An “impact-generation deactivation unit” in particular means a unit provided to allow an operator to switch off the impact-generation unit for a drilling and/or screwing operation. The impact-generation deactivation unit preferably prevents an especially automatic activation of the impact-generation unit when an inserted tool is pressed against a workpiece in a drilling and/or screwing mode. The pressure application in a cutting and/or impact drilling mode preferably causes an axial displacement of the clamping chuck drive shaft. The blocking element is advantageously provided to prevent an axial displacement of the clamping chuck drive shaft, the clamping chuck and/or advantageously the snap die in the drilling and/or screw-fitting mode. “Parallel to a force” in particular means that the clamping chuck drive shaft and the blocking element apply a force to the snap die at two different locations in at least one operating state. As an alternative or in addition, the clamping chuck drive shaft and the blocking element are able to exert a force on the clamping chuck at two different locations in at least one operating state. The forces preferably have a component that is oriented in the same direction, i.e., preferably parallel to the axis of rotation of the clamping chuck drive shaft, from the clamping chuck drive shaft in the direction of the clamping chuck. The blocking element preferably acts on the snap die directly, but especially preferably, at least via a clamping chuck bearing. Preferably, the clamping chuck drive shaft is acting directly on the snap die. The snap die preferably transmits a rotary motion from the clamping chuck drive shaft to the clamping chuck.

Moreover, a handheld tool is provided, which includes a hammer mechanism according to the present invention. A “handheld tool” in this context in particular describes a handheld tool that appears useful to the expert, but preferably a drilling machine, an impact drill, a screw driller, a boring tool and/or an impact drilling machine. The handheld tool preferably is developed as a battery-operated handheld tool, i.e., the handheld tool in particular includes a coupling means provided to supply a drive motor of the handheld tool with electrical energy from a handheld tool battery pack connected to the coupling means.

### BRIEF DESCRIPTION OF THE DRAWINGS

FIG. 1 shows A handheld tool having a hammer mechanism according to the present invention, in a perspective view.

FIG. 2 shows a section of the hammer mechanism of FIG. 1.

FIG. 3 shows a coupling means, a clamping chuck drive shaft, a snap die, and a portion of a clamping chuck of the hammer mechanism from FIG. 1, shown individually in a perspective view in each case.

FIG. 4 shows another part-sectional view of the hammer mechanism from FIG. 1, which shows an impact-generation deactivation unit of the hammer mechanism.

FIG. 5 shows a first alternative exemplary embodiment of a snap die of the hammer mechanism from FIG. 1 in a schematic representation.

FIG. 6 shows a second alternative exemplary embodiment of a snap die of the hammer mechanism from FIG. 1 in a schematic representation.

FIG. 7 shows a third alternative exemplary embodiment of a snap die of the hammer mechanism from FIG. 1 in a sectional view.

FIG. 8 shows the snap die from FIG. 7 in a first perspective view.

FIG. 9 shows the snap die from FIG. 7 in a second perspective view.

FIG. 10 shows a portion of a clamping chuck of the hammer mechanism of FIG. 7 in a perspective view.

FIG. 11 shows a fourth alternative exemplary embodiment of a snap die of the hammer mechanism from FIG. 1 in a schematic representation.

### DETAILED DESCRIPTION OF THE INVENTION

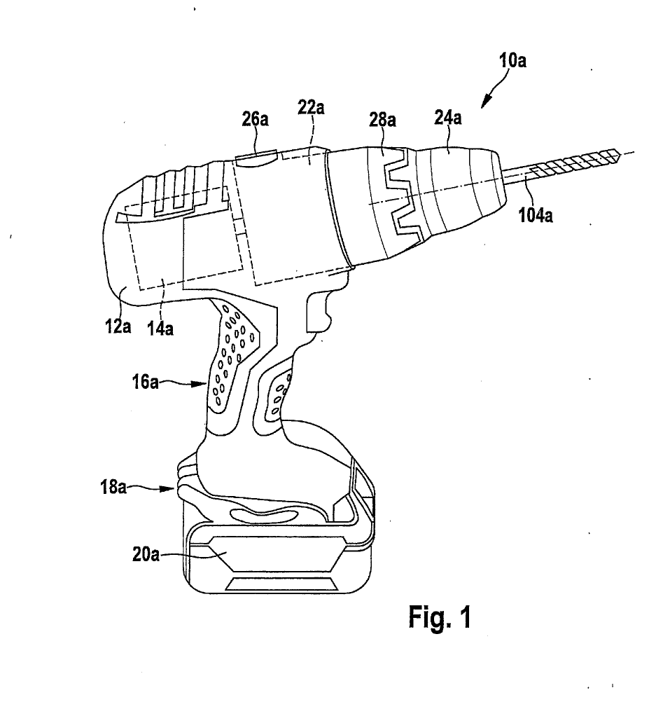

FIG. 1 shows a handheld tool 10a, which is developed as impact drill screwer. Handheld tool 10a has a pistol-shaped housing 12a. A drive motor 14a of handheld tool 10a is situated inside housing 12a. Housing 12a has a handle region 16a and a battery coupling means 18a, which is disposed at an end of handle region 16a facing away from drive motor 14a. Battery coupling means 18a links a handheld tool battery 20a, which link is severable by an operator either electrically or mechanically. Handheld tool battery 20a has an operating voltage of 10.8 Volt, but could also have a different, especially higher, operating voltage. Furthermore, handheld tool 10a is provided with a hammer mechanism 22a according to the present invention, which includes a clamping chuck 24a disposed on the outside, and operating elements 26a, 28a.

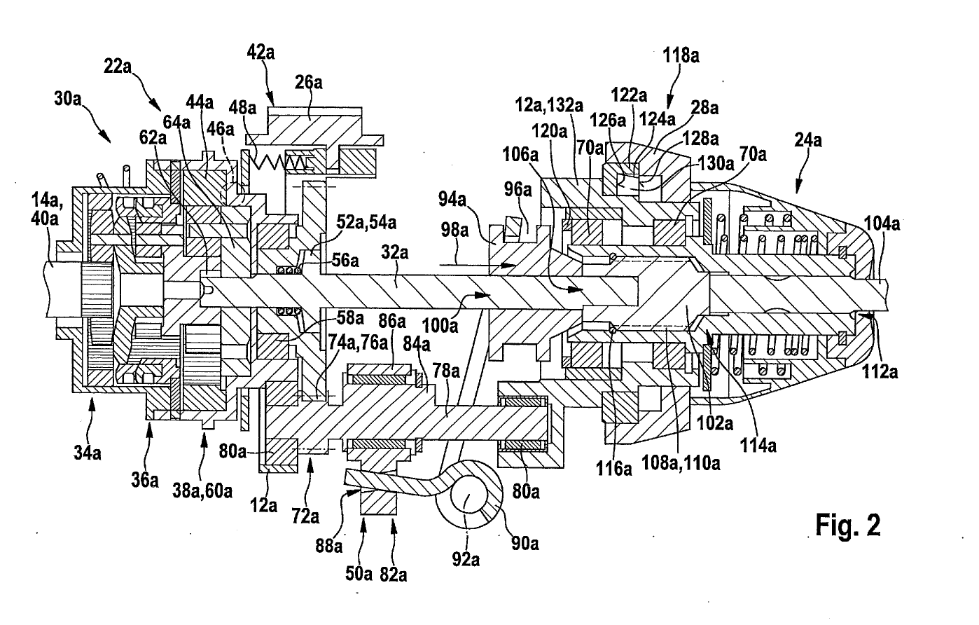

FIG. 2 shows hammer mechanism 22a in a sectional view. Hammer mechanism 22a also includes a planetary gearing 30a and a clamping chuck drive shaft 32a. When in operation, planetary gearing 30a drives clamping chuck drive shaft 32a in rotary motions about an axis of rotation. Planetary gearing 30a has three planetary gear stages 34a, 36a, 38a for this purpose. An operator is able to adjust the transmission ratio of planetary gearing 30a between a rotor 40a of drive motor 14a and clamping chuck drive shaft 32a in at least two stages. As an alternative, a transmission ratio between drive motor 14a and clamping chuck drive shaft 32a could also be designed to be non-adjustable.

Hammer mechanism 22a is equipped with a torque restriction device 42a. While in operation, torque restriction device 42a fixates a ring gear 44a of planetary gearing 30a. Torque restriction device 42a has fixation balls 46a for this purpose, which engage with recesses of ring gear 44a. A spring 48a of torque restriction device 42a exerts a force on fixation balls 46a, in the direction of ring gear 44a. Using one of operating elements 26a, the operator is able to move an end of spring 48a facing fixation balls 46a in the direction of fixation balls 46a. Operating element 26a includes an eccentric element for this purpose. Thus, the force acting on fixation balls 46a is adjustable. If a particular maximum torque has been reached, fixation balls 46a are pushed out of the recesses and ring gear 44a runs freely, thereby interrupting a force transmission between rotor 40a and clamping chuck drive shaft 32a. Torque restriction device 42a thus serves the purpose of restricting a maximum torque transmittable via clamping chuck drive shaft 32a.

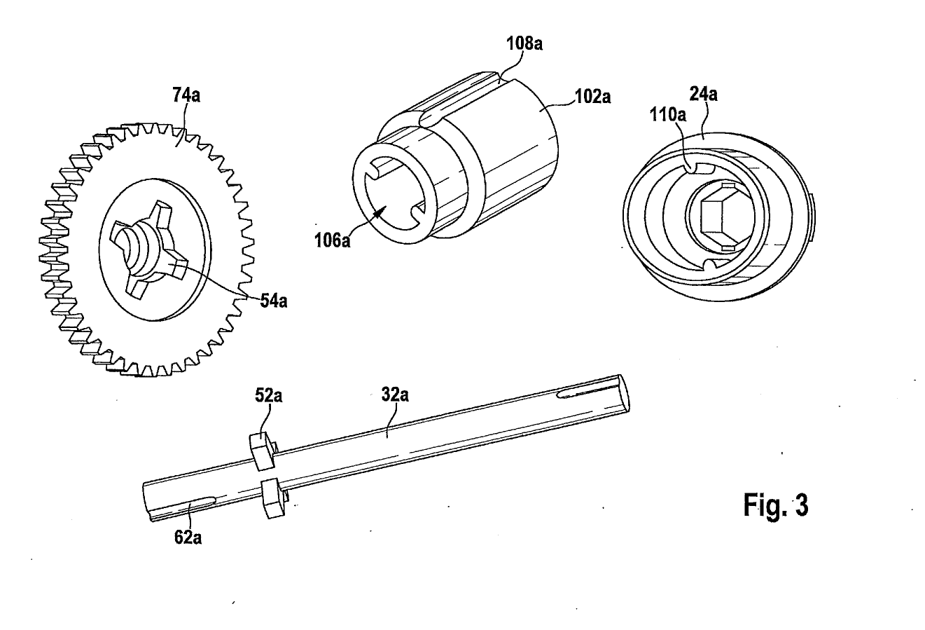

Hammer mechanism 22a includes an impact-generation unit 50a and a first coupling means 52a. First coupling means 52a is connected to clamping chuck drive shaft 32a in torsionally fixed manner, first coupling means 52a and clamping chuck drive shaft 32a being formed in one piece, in particular. Impact-generation unit 50a is provided with a second coupling means 54a which is connected to first coupling means 52a in torsionally fixed manner in a drilling and/or impact drilling mode. As shown in FIG. 3 as well, first coupling means 52a are developed as premolded shapes and second coupling means 54a are developed as recesses. When the drilling mode is activated, first coupling means 52a dips into second coupling means 54a, i.e., to the full extent. As a result, the coupling between first coupling means 52a and second coupling means 54a is reversible by axial shifting of clamping chuck drive shaft 32a in the direction of clamping chuck 24a. A spring 56a of hammer mechanism 22a is situated between first coupling means 52a and second coupling means 54a. Spring 56a presses clamping chuck drive shaft 32a in the direction of clamping chuck 24a. When impact-generation unit 50a is deactivated, it opens the link between first coupling means 52a and second coupling means 54a.

Hammer mechanism 22a is provided with a first bearing 58a, which fixates second coupling means 54a relative to housing 12a in the axial direction and rotationally mounts it coaxially with clamping chuck drive shaft 32a. Furthermore, hammer mechanism 22a includes a second bearing 60a, which rotationally mounts clamping chuck drive shaft 32a on a side facing drive motor 14a, such that it is able to rotate about the axis of rotation. Second bearing 60a is developed in one piece with with one of the three planetary gear stages 38a. Clamping chuck drive shaft 32a is provided with a coupling means 62a, which connects it to a planet carrier 64a of this planetary gear stage 38a in axially displaceable and torsionally fixed manner. As a result, this planetary gear stage 38a serves the purpose of mounting clamping chuck drive shaft 32a in axially displaceable manner. On a side facing clamping chuck 24a, clamping chuck drive shaft 32a together with clamping chuck 24a is rotationally mounted with the aid of a clamping chuck bearing 70a. Clamping chuck bearing 70a has a rear bearing element which, axially fixated, is pressed onto clamping chuck 24a. In addition, clamping chuck bearing 70a has a front bearing element which supports clamping chuck 24a inside housing 12a in axially displaceable manner.

Impact-generation unit 50a includes a spur gear transmission stage 72a, which translates a rotational speed of clamping chuck drive shaft 32a into a higher rotational speed for impact generation. A first toothed wheel 74a of spur gear transmission stage 72a is integrally formed with second coupling means 54a. In an impact drilling operation, it is driven by clamping chuck drive shaft 32a. A second toothed wheel 76a of spur gear transmission stage 72a is integrally formed with a hammer mechanism shaft 78a. An axis of rotation of hammer mechanism shaft 78a is disposed next to the axis of rotation of clamping chuck drive shaft 32a in the radial direction. Impact-generation unit 50a includes two bearings 80a, which mount hammer mechanism shaft 78a in axially fixed and rotatable manner. Impact-generation unit 50a includes a drive means 82a, which translates a rotary motion of hammer mechanism shaft 78a into a linear motion. An eccentric element 84a of drive means 82a is integrally formed with hammer mechanism shaft 78a. Using a needle roller bearing, for example, an eccentric sleeve 86a of drive means 82a is mounted on eccentric element 84a in a manner that allows it to rotate relative thereto. Eccentric sleeve 86a has a recess 88a, which encloses a rocker lever 90a of impact-generation unit 50a.

Rocker lever 90a is pivotably mounted on a pivot axle 92a of impact-generation unit 50a, that is to say, it is able to pivot about an axis that runs perpendicularly to the axis of rotation of clamping chuck drive shaft 32a. An end of rocker lever 90a facing away from drive means 82a partially encloses a strike means 94a of hammer mechanism 22a. In so doing, the rocker lever engages with a recess 96a of strike means 94a. Recess 96a is developed in the form of a ring. In an impact drilling operation, rocker lever 90a exerts a force on strike means 94a, which accelerates it. Rocker lever 90a is moved in a sinusoidal pattern while in operation. Rocker lever 90a has a spring-elastic design. It has a spring constant between eccentric sleeve 86a and strike means 94a that is less than 100 N/mm and greater than 10 N/mm. In this particular exemplary embodiment, rocker lever 90a has a spring constant of approximately 30 N/mm.

Clamping chuck drive shaft 32a mounts strike means 94a so that it is movable in strike direction 98a. Strike means 94a delimits a recess 100a for this purpose. Clamping chuck drive shaft 32a penetrates strike means 94a through recess 100a. In so doing, strike means 94a encloses recess 100a to 360 degrees in a plane perpendicular to recess 100a. When operated, strike means 94a strikes a snap die 102a of hammer mechanism 22a. Snap die 102a is situated between an inserted tool 104a and strike means 94a. In the operative state, inserted tool 104a is fixed in place in clamping chuck 24a. Clamping chuck 24a mounts snap die 102a in a manner that allows it to move parallel to strike direction 98a. In an impact drilling operation, snap die 102a transmits strike pulses originating from strike means 94a to inserted tool 104a.

Clamping chuck drive shaft 32a is connected to snap die 102a in axially movable and torsionally fixed manner. Snap die 102a delimits a recess 106a for this purpose. When in an operative state, clamping chuck drive shaft 32a is partially situated inside recess 106a of snap die 102a. Clamping chuck drive shaft 32a is rotationally mounted with the aid of snap die 102a, clamping chuck 24a and clamping chuck bearing 70a. Clamping chuck 24a is rotationally driven by way of snap die 102a. Clamping chuck 24a and snap die 102a are each provided with a coupling means 108a, 110a for this purpose, the coupling means being provided to transmit the rotary motion to clamping chuck 24a. Coupling means 108a of snap die 102a is developed in the form of a groove, whose main extension runs parallel to strike direction 98a. Coupling means 108a extends along a radially outward-lying surface area of snap die 102a. Coupling means 110a of clamping chuck 24a is developed as a protrusion that fits the groove.

Clamping chuck 24a includes an inserted-tool coupling region 112a, in which inserted tool 104a is fixed in strike direction 98a during a drilling a screwing operation, or in which it is mounted in moveable manner in strike direction 98a during an impact-drilling operation. In addition, the clamping chuck includes a tapered region 114a, which delimits a movement range of snap die 102a in strike direction 98a. Furthermore, clamping chuck 24a is provided with a mounting ring 116a, which delimits a movement range of snap die 102a counter to strike direction 98a.

During an impact drilling operation, an operator presses inserted tool 104a against a workpiece (not shown further). The operator thereby shifts inserted tool 104a, snap die 102a and clamping chuck drive shaft 32a relative to housing 12a, in a direction counter to the strike direction 98a, i.e., in the direction of drive motor 14a. In so doing, the operator compresses spring 56a of hammer mechanism 22a. First coupling means 52a dips into second coupling means 54a, so that clamping chuck drive shaft 32a begins to drive impact-generation unit 50a. When the operator stops pressing inserted tool 104a against the workpiece, spring 56a shifts clamping chuck drive shaft 32a, snap die 102a and inserted tool 104a in strike direction 98a. This releases a torsionally fixed connection between first coupling means 52a and second coupling means 54a, and thereby switches impact-generation unit 50a off.

Hammer mechanism 22a has an impact-generation deactivation unit 118a which includes a blocking element 120a, a sliding block guide 122a, and operating element 28a. In a drilling or screwing mode, blocking element 120a exerts a force on snap die 102a, which acts on snap die 102 parallel to at least one force of clamping chuck drive shaft 32a. The force of blocking element 120a acts on snap die 102a via clamping chuck bearing 70a, clamping chuck 24a, and mounting ring 116a. The force of blocking element 120a prevents an axial displacement of snap die 102a and clamping chuck drive shaft 32a during a drilling and screwing mode, and thus prevents an activation of impact-generation unit 50a. The force of clamping chuck drive shaft 32a has a functionally parallel component which drives snap die 102a in rotating fashion during operation. In addition, the force has a functionally and directionally parallel component which is brought to bear on snap die 102a by spring 56a via clamping chuck drive shaft 32a.

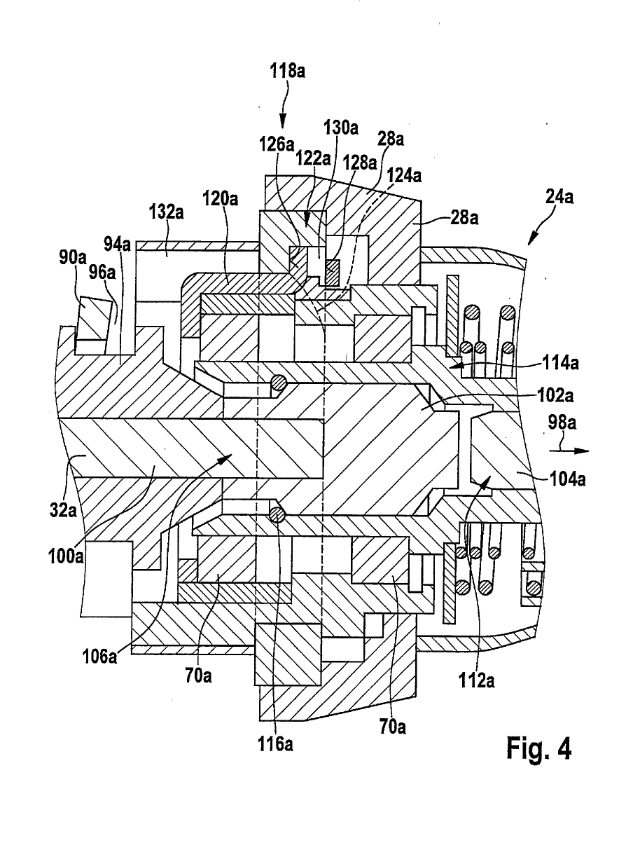

FIG. 4 shows a section that runs perpendicularly to the section of FIG. 2 and parallel to strike direction 98a, in which operating element 28a is disposed in two different positions in the sections of FIGS. 2 and 4. Operating element 28a is developed in the form of a ring. It coaxially encloses the axis of rotation of clamping chuck drive shaft 32a. Operating element 28a is rotatable and connected to sliding block guide 122a in torsionally fixed manner. Sliding block guide 122a is likewise developed in the form of a ring. Sliding block guide 122a is provided with a bevel 124a. Bevel 124a connects two surfaces 126a, 128a of sliding block guide 122a. Surfaces 126a, 128a are aligned perpendicularly to strike direction 98a. Surfaces 126a, 128a are disposed in different planes in strike direction 98a.

In an impact drilling mode, blocking element 120a is situated inside a recess 130a, which is delimited, for one, by bevel 124a and one of surfaces 126a. This surface 126a is situated closer to drive motor 14a than the other surface 128a. Housing 12a has a housing element 132a, which mounts the blocking element in torsionally fixed manner and allows it to move in strike direction 98a. As a result, blocking element 120a, together with clamping chuck 24a, is able to be pressed in a direction counter to the strike direction 98a at the start of an impact-drilling operation. In an impact-drilling operation, blocking element 120a does not exert any blocking force on clamping chuck 24a. When operating element 28a of impact-generation deactivation unit 118a is rotated, blocking element 120a is moved through bevel 124a in strike direction 98a. In the drilling or screwing mode, blocking element 120a is kept in this frontal position. Blocking element 120a thereby prevents axial shifting of clamping chuck drive shaft 32a in the drilling or screwing mode.

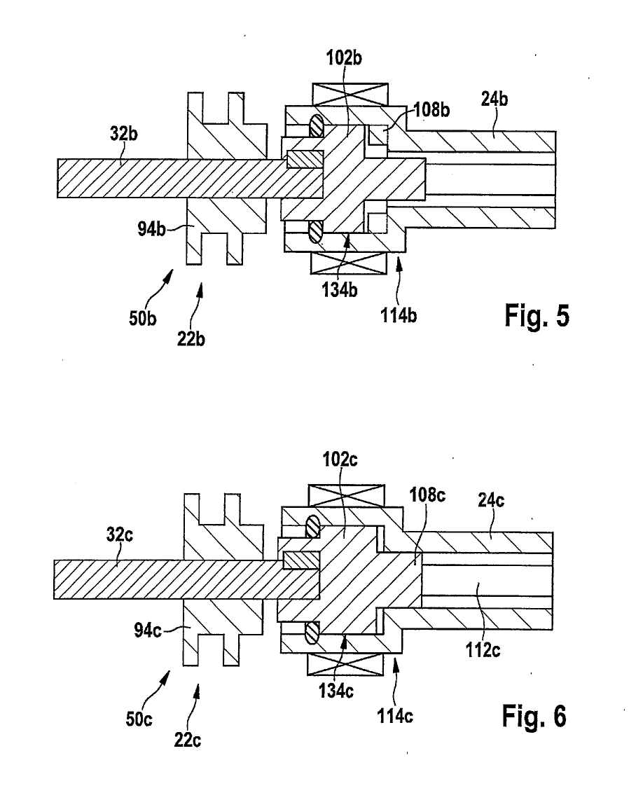

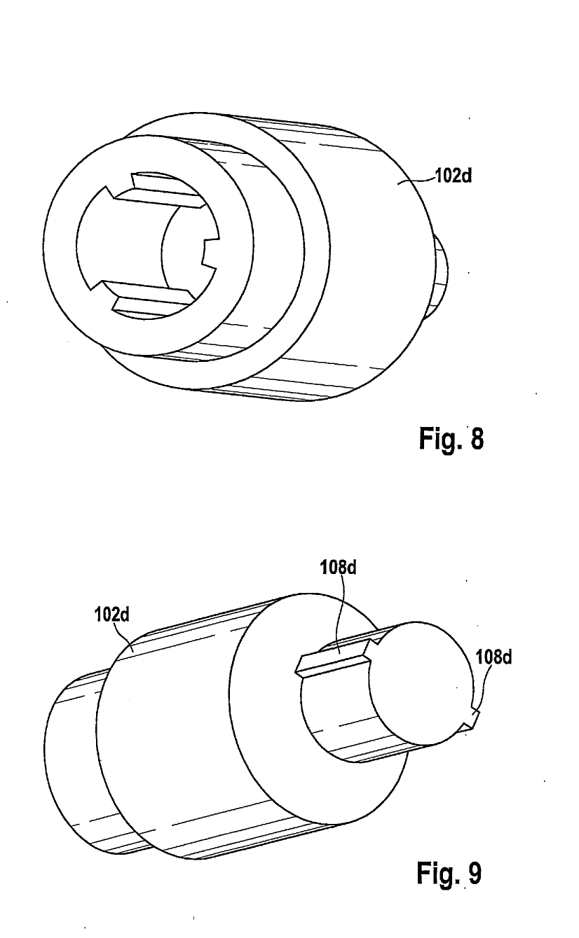

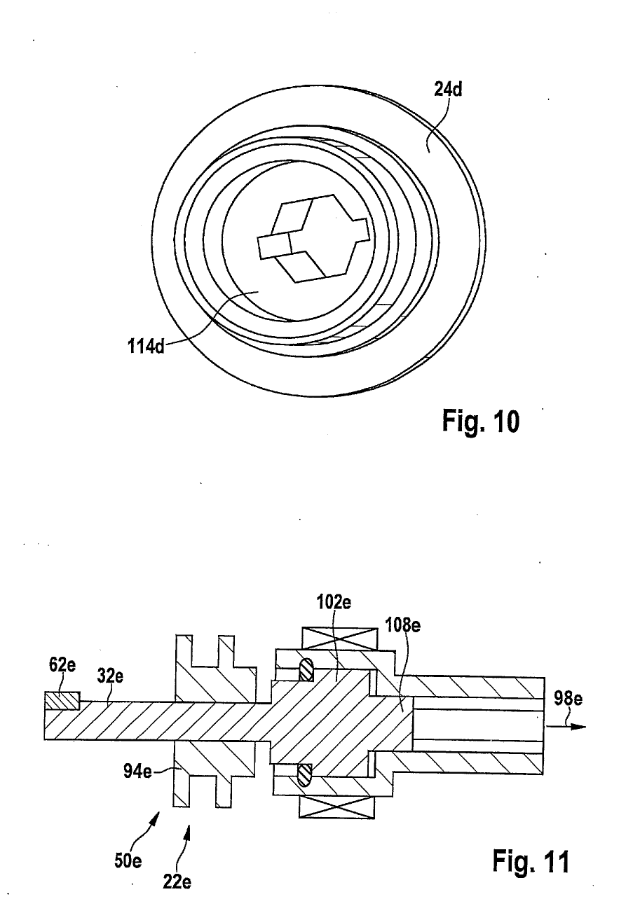

FIGS. 5 through 11 show additional exemplary embodiments of the present invention. The following descriptions and the figures are essentially limited to the differences between the exemplary embodiments. Regarding components designated in the same way, particularly regarding components provided with identical reference numerals, it is basically also possible to refer to the drawings and/or the description of the other exemplary embodiments, especially of FIGS. 1 through 4. In order to distinguish the exemplary embodiments, the letter a has been added after the reference numerals of the exemplary embodiment in FIGS. 1 through 4. In the exemplary embodiments of FIGS. 5 through 11, the letter a has been replaced by the letters b through e.

FIG. 5 shows a portion of a hammer mechanism 22b. A hammer means 94b of an impact-generation unit 50b of hammer mechanism 22b is mounted in movable manner on a clamping chuck drive shaft 32b of hammer mechanism 22b. Clamping chuck drive shaft 32b is joined to a snap die 102b of hammer mechanism 22b in torsionally fixed and axially displaceable manner. Snap die 102b is provided with a coupling means 108b which forms a torsionally fixed connection to a clamping chuck 24b of hammer mechanism 22b in at least one operating state. Coupling means 108b is situated on a side that is facing a tapered region 114b of clamping chuck 24b. Coupling means 108b is developed as teething. A sealing region 134b of the snap die is resting against clamping chuck 24b without gear teeth and advantageously prevents dust from entering impact generation unit 50b.

FIG. 6, like FIG. 5, schematically illustrates a portion of hammer mechanism 22c. A hammer means 94b of an impact-generation unit 50c of hammer mechanism 22c is mounted in movable manner on a clamping chuck drive shaft 32c of hammer mechanism 22c. Clamping chuck drive shaft 32c is joined to a snap die 102b of hammer mechanism 22c in torsionally fixed and axially displaceable manner. Snap die 102c includes a coupling means 108c which forms a torsionally fixed connection to a clamping chuck 24c of hammer mechanism 22c in at least one operating state. Clamping chuck 24c has an inserted-tool coupling region 112c, in which coupling means 108c of snap die 102c at least partially engages. One inserted-tool coupling region 112c is provided to exert forces on an inserted tool in the peripheral direction during operation. In an operative state, coupling means 108c is at least partially disposed inside a tapered region 114c of clamping chuck 24c. Coupling means 108c is developed in the form of an external hexagon. The dimensions of the external hexagon correspond to the usual dimensions of a bit for a screwing operation. A sealing region 134c of the snap die 102c rests against clamping chuck 24c without gear teeth and advantageously prevents dust from entering impact-generation unit 50b in a cost-effective manner. Especially fat loss is able to be minimized.

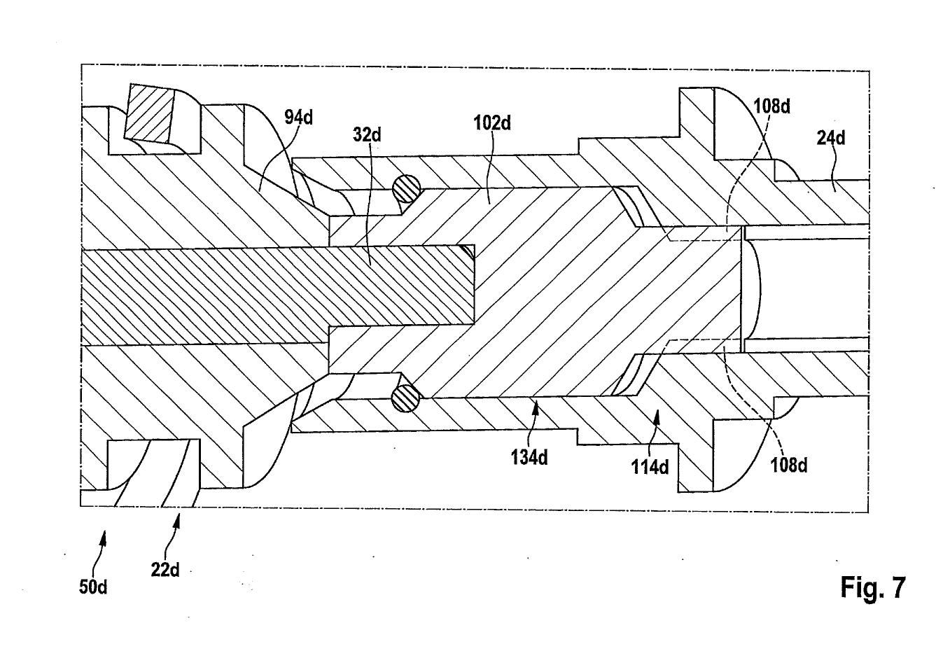

FIGS. 7 through 10 also show a portion of a hammer mechanism 22d as a section and a perspective view. A hammer means 94d of an impact-generation unit 50d of hammer mechanism 22d is mounted in movable manner on a clamping chuck drive shaft 32d of hammer mechanism 22d. Clamping chuck drive shaft 32d is joined to a snap die 102d of hammer mechanism 22d in torsionally fixed and axially displaceable manner. Snap die 102d includes a coupling means 108d, which in at least one operating state forms a torsionally fixed connection to a clamping chuck 24d of hammer mechanism 22d. In an operative state, coupling means 108d is at least partially disposed inside a tapered region 114d of clamping chuck 24d. Coupling means 108d is developed as teething and has two coupling ribs lying opposite each other in relation to the axis of rotation. Coupling means 108d has the same form and the same dimensions as a coupling means for the coupling with an insertion tool. The form and the dimensions correspond to those of the SDS Quick standard. A sealing region 134d of snap die 102d rests against clamping chuck 24d without gear teeth.

FIG. 11, like FIG. 5, schematically illustrates a portion of hammer mechanism 22e. A hammer means 94e of an impact-generation unit 50e of hammer mechanism 22e is mounted in movable manner on a clamping chuck drive shaft 32e of hammer mechanism 22e. Clamping chuck drive shaft 32e is joined to a snap die 102e of hammer mechanism 22e in torsionally and axially fixed manner. Clamping chuck drive shaft 32e and snap die 102e are developed in one piece. During a strike, hammer means 94e moves both clamping chuck drive shaft 32e and snap die 102e in strike direction 98e. With the aid of a coupling means 62e, clamping chuck drive shaft 32e is connected in axially displaceable and torsionally fixed manner to a planetary-gear stage described in the exemplary embodiment of FIGS. 1 through 4.

1-12. (canceled)

13. A hammer mechanism, comprising:
at least one impact-generation unit having a strike element;
a clamping chuck drive shaft which mounts the strike element in a movable manner in a strike direction in at least one operating state; and
a coupling element which is connected to the clamping chuck drive shaft in a torsionally fixed manner and drives the impact-generation unit.

14. The hammer mechanism as recited in claim 13, wherein the coupling element and the clamping chuck drive shaft are configured as a single piece.

15. The hammer mechanism as recited in claim 13, wherein the coupling element is configured to dip into a coupling arrangement of the impact-generation unit when at least one strike mode is activated.

16. The hammer mechanism as recited in claim 15, wherein the clamping chuck drive shaft at least partially penetrates the strike element.

17. The hammer mechanism as recited in claim 15, further comprising:
at least one bearing which is provided to mount the clamping chuck drive shaft in an axially displaceable manner.

18. The hammer mechanism as recited in claim 15, further comprising:
a planetary gearing which drives the clamping chuck drive shaft in at least one operating state.

19. The hammer mechanism as recited in claim 18, wherein the clamping chuck drive shaft includes an additional coupling element which is provided to produce an axially displaceable, torsionally fixed connection to the planetary gearing.

20. The hammer mechanism as recited in claim 15, further comprising:
a torque restriction device which restricts a torque transmitted via the clamping chuck drive shaft to a predetermined maximum permissible torque.

21. The hammer mechanism as recited in claim 15, further comprising:
a clamping chuck and a snap die having a coupling arrangement provided to transmit a rotary motion to the clamping chuck.

22. The hammer mechanism as recited in claim 15, wherein the impact-generation unit has a spur gear transmission stage which translates a rotational speed of the clamping chuck drive shaft into a higher rotational speed for impact generation.

23. The hammer mechanism as recited in claim 21, further comprising:
an impact-generation deactivation unit having a blocking element which, at least in a drilling operation, acts on the snap die parallel to a force of the clamping chuck drive shaft.

24. The hammer mechanism as recited in claim 23, wherein the hammer mechanism is a part of a handheld tool.
